(19) United States
(12) Patent Application Publication
(10) Pub. No.: US 2009/0169729 A1
(43) Pub. Date: Jul. 2, 2009

(54) MANUFACTURING APPARATUS AND METHOD OF CONDUCTIVE FIBER

(75) Inventors: Yung-Tan Lin, Taipei Hsien (TW); Kuang-Kuo Sun, Taipei Hsien (TW)

Correspondence Address: J C PATENTS, INC., 4 VENTURE, SUITE 250, IRVINE, CA, 92618, US

(73) Assignee: TAIWAN TEXTILE RESEARCH INSTITUTE, Taipei Hsien (TW)

(21) Appl. No.: 12/193,451

(22) Filed: Aug. 18, 2008

(30) Foreign Application Priority Data
Dec. 31, 2007 (TW) 96151530

(51) Int. Cl. B05D 5/00; B05C 13/02

(52) U.S. Cl. 427/120; 118/500

(57) ABSTRACT

A manufacturing apparatus of conductive fiber is provided. The manufacturing apparatus includes a spinning unit, a conductive wire supply unit, and an insulating material supply unit. The spinning unit has at least one spinneret. The spinneret has a wire lead-in portion and a liquid lead-in portion connected with the wire lead-in portion. The liquid lead-in portion has a containing space and a capillary, and the wire lead-in portion is disposed in the containing space. The conductive wire supply unit is connected with the wire lead-in portion to lead a conductive wire through the capillary. The insulating material supply unit is connected with the liquid lead-in portion to supply a liquid insulating material to the containing space. The liquid insulating material is covered on the surface of the conductive wire passing through the capillary.

### CROSS-REFERENCE TO RELATED APPLICATION

This application claims the priority benefit of Taiwan application serial no. 96151530, filed on Dec. 31, 2007. The entirety of the above-mentioned patent application is hereby incorporated by reference herein and made a part of specification.

### BACKGROUND OF THE INVENTION

1. Field of the Invention

The present invention generally relates to a manufacturing apparatus and method of conductive fiber, in particular, to a manufacturing apparatus and method of conductive fiber for fabricating the conductive fiber with high conductivity and superior dyeing behavior.

2. Description of Related Art

With the progress of technology, many industries (for example, petrochemical, electronics, biotechnology, etc.) have higher requirement on the prevention of static electricity and particulate pollution in the dust-free environment. In the common dust-free environment, the static electricity and the particulate pollution may easily cause defects of the products, which adversely affects the process yield and the production cost. Therefore, anti-static fabrics plays a quite important role in the dust-free environment.

The antistatic fabrics is generally fabricated by yarns of common and conductive materials. The conductive yarn is formed by a metal yarn (such as a copper yarn and a stainless stain yarn) covered by yarns of the common material. For example, as disclosed in Japanese patent No. 4,793,130, the metal fiber serving as the core yarn is covered with a natural fiber or synthetic fiber by a covering machine so as to form the core yarn. However, in the above method, a plurality of subsequent processes are required for forming the conductive yarn, and need more time, which goes against the current market requirements of efficiency and furious competition.

In addition, another manufacturing method of the conductive yarn involves adding a conductive material to the core-sheath structure fiber. For example, as disclosed in Japanese patent laid-open publication NO. 10-28245, the core-sheath structure fiber using composite spinning is used, in which the conductive material (such as carbon black and titanium oxide) is added into the core to form the conductive yarn. However, the above method needs a discharging process to form the conductive yarn, and effects only if a distance between the conductive material in the core and the conductive yarn surface is 1.0 μm, which causes a higher difficulty in the mass production of the conductive yarn.

### SUMMARY OF THE INVENTION

Accordingly, the present invention is directed to a manufacturing apparatus of conductive fiber, for manufacturing the conductive fiber with high conductivity and superior dyeing behavior.

The present invention is also directed to a manufacturing method of a conductive fiber, which has simplified steps of producing the conductive fiber to achieve the purpose of mass production of the conductive fiber.

The present invention provides a manufacturing apparatus of a conductive fiber, which includes a spinning unit, a conductive wire supply unit, and an insulating material supply unit. The spinning unit has at least one spinneret. The spinneret has a wire lead-in portion and a liquid lead-in portion connected with the wire lead-in portion. The liquid lead-in portion has a containing space and a capillary, and the wire lead-in portion is disposed in the containing space. The conductive wire supply unit is connected with the wire lead-in portion to lead a conductive wire through the capillary. The insulating material supply unit is connected with the liquid lead-in portion to supply a liquid insulating material to the containing space. The liquid insulating material is covered on the surface of the conductive wire passing through the capillary.

In the manufacturing apparatus of a conductive fiber according to an embodiment of the present invention, the conductive wire supply unit includes a wire. creel and a wire driving device. The wire driving device is disposed between the wire creel and the spinneret.

In the manufacturing apparatus of a conductive fiber according to an embodiment of the present invention, the conductive wire supply unit further includes a heater disposed between the wire creel and the wire driving device.

In the manufacturing apparatus of a conductive fiber according to an embodiment of the present invention, the conductive wire supply unit further includes a surfactant coater disposed between the wire creel and the wire driving device.

In the manufacturing apparatus of a conductive fiber according to an embodiment of the present invention, the conductive wire supply unit farther includes a drying machine disposed between the surfactant coater and the heater.

In the manufacturing apparatus of a conductive fiber according to an embodiment of the present invention, the insulating material supply unit includes a feeder, a spinning pump, and an extruder. The spinning pump is connected with the spinneret. The extruder is connected between the feeder and the spinning pump.

In the manufacturing apparatus of a conductive fiber according to an embodiment of the present invention, the manufacturing apparatus further includes a coiling unit and a cooling unit. The coiling unit is used to coil the conductive wire with the surface thereof covered by the insulating material. The cooling unit is disposed between the spinning unit and the coiling unit, so as to cure the insulating material to an insulating layer.

In the manufacturing apparatus of a conductive fiber according to an embodiment of the present invention, the manufacturing apparatus further includes a feeding unit disposed between the coiling unit and the cooling unit.

The present invention further provides a manufacturing method of a conductive fiber. First, a spinneret is provided. The spinneret has a wire lead-in portion disposed in the containing space and a liquid lead-in portion having a containing space and a capillary. Then, a liquid insulating material is led into the containing space. Next, a conductive wire is forced to pass through the capillary by the wire lead-in portion, such that the liquid insulating material is covered on a surface of the conductive wire. Then, the liquid insulating material is cooled so as to form an insulating layer on the surface of the conductive wire.

In the manufacturing method of a conductive fiber according to an embodiment of the present invention, the liquid insulating material is, for example, provided into the containing space by an insulating material supply unit.

In the manufacturing method of a conductive fiber according to an embodiment of the present invention, a temperature of the liquid insulating material led into the containing space is between 200° C. and 310° C.

In the manufacturing method of a conductive fiber according to an embodiment of the present invention, a diameter of the wire is between 0.02 mm and 0.18 mm.

In the manufacturing method of a conductive fiber according to an embodiment of the present invention, the manufacturing method further includes performing a dyeing or bulking process on the insulating layer.

In the manufacturing method of a conductive fiber according to an embodiment of the present invention, the manufacturing method further includes coiling the conductive wire with the surface thereof covered by the insulating layer.

In the present invention, the insulating layer is formed on the surface of the conductive wire by means of simultaneously providing the conductive wire and the liquid insulating material into the spinneret, so as to simplify the steps of manufacturing the conductive fiber and accelerate the production of the conductive fiber, and also achieve the purpose of mass production. In addition, an outer layer of the conductive fiber manufactured according to the manufacturing apparatus and method of the present invention is the common synthetic fiber, and thus the dyeing step may be easily performed thereon to form the color yarn. In addition, the conductive fiber manufactured according to the manufacturing apparatus and method of the present invention has high conductivity.

In order to the make aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a manufacturing apparatus of the conductive fiber according to an embodiment of the present invention.

FIG. 2 is a schematic cross-sectional view of a spinneret according to the embodiment of the present invention.

FIG. 3 is a flow chart of a manufacturing method of a conductive fiber according to the embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

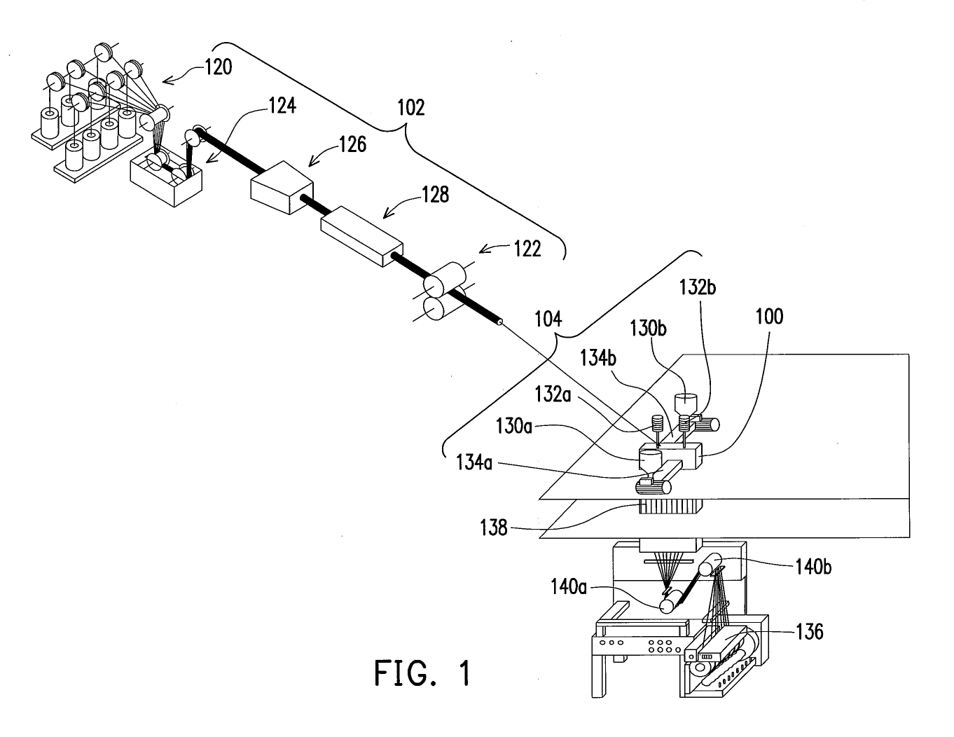

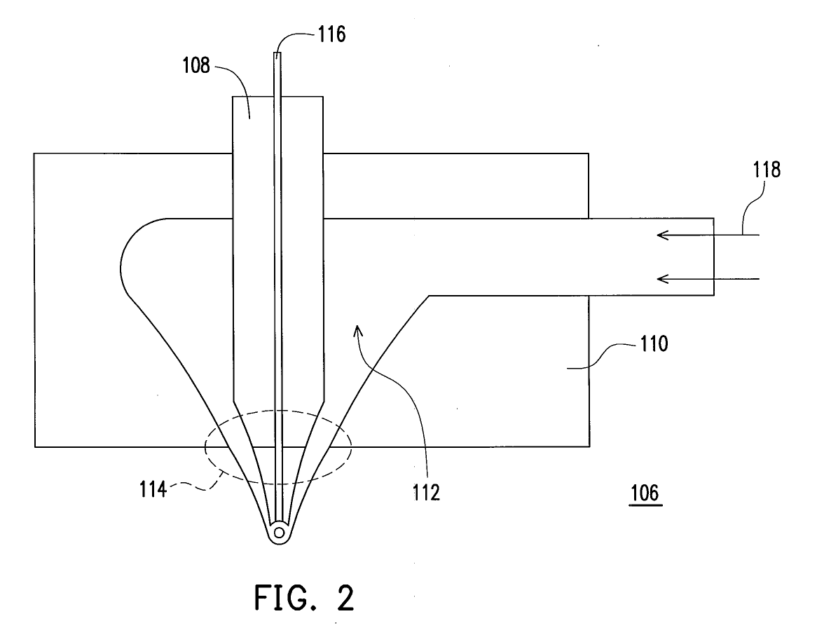

FIG. 1 is a schematic view of a manufacturing apparatus of the conductive fiber according to an embodiment of the present invention, and FIG. 2 is a schematic cross-sectional view of a spinneret according to the embodiment of the present invention.

Referring to FIGS. 1 and 2, the manufacturing apparatus for a conductive fiber includes a spinning unit 100, a conductive wire supply unit 102, and an insulating material supply unit 104. In this embodiment, the spinning unit 100 has at least one spinneret 106. Definitely, in other embodiments, one or more than one spinnerets may be disposed as required. The spinneret 106 has a wire lead-in portion 108 and a liquid lead-in portion 110 connected with the wire lead-in portion 108. The liquid lead-in portion has a containing space 112 and a capillary 114, and the wire lead-in portion 108 is disposed in the containing space 112. The conductive wire supply unit 102 is connected with the wire lead-in portion 108 to lead the conductive wire 116 passing through the capillary 114. The conductive wire 116 is made of, for example, metal (copper or stainless steel). The insulating material supply unit 104 is connected with the liquid lead-in portion 110, so as to supply the liquid insulating material 118 into the containing space 112. When the liquid insulating material 118 is supplied into the containing space 112 and the conductive wire 116 passes through the capillary 114, the liquid insulating material 118 is covered on the surface of the conductive wire 116 (as shown in FIG. 2). The insulating material 118 is, for example, polyethylene terephthalate (PET), polyamide (PA), polypropylene (PP), or polyethylene (PE).

The conductive wire supply unit 102 includes a wire creel 120 and a wire driving device 122. The wire driving device 122 is disposed between the wire creel 120 and the spinneret 106. In addition, a surfactant coater 124, a drying machine 126, and a heater 128 may be disposed in sequence between the wire creel 120 and the wire driving device 122. When the conductive wire 116 passes through the surfactant coater 124, a layer of surfactant may be formed on the surface of the conductive wire 116, thereby enhancing the adhesion between the conductive wire 116 and the insulating material 118. The overall sheet resistance of the conductive fiber is affected by the layer of surfactant and the adhesion between the conductive wire 116 and the insulating material 118 when different surfactants are used is shown in Table I. In the weaved conductive fiber, the insulating material 118 is broken and the conductive wire 116 is exposed, when the conductive wire 116 and the insulating material 118 is adhered with the surfactant with functional group containing titanium (Sample 1). Therefore, the sheet resistance of the conductive fiber is about 8.82×10⁵Ω (Testing standard: EN 1149-1; 2006). In the Samples 2 to 4, the sheet resistance of the conductive fiber is much higher than that of the Sample 1. Additionally, the conductive fiber of Samples 1 to 4 are good in conducting or releasing the ESD since the half-life of ESD of each Sample is smaller 0.01 second.

| | | | Sheet | |
|---|---|---|---|---|
| | | | resistance | Half-life of |
| | Surfactant | interface | (Ω) | ESD (second) |
| Sample A | Surfactant with | Excellent | 8.82 × 10⁵ | <0.01 |
| | functional group | | | |
| | containing Ti | | | |
| Sample B | Surfactant with | Good | 4.26 × 10¹⁰ | <0.01 |
| | functional group | | | |
| | containing Si | | | |
| Sample C | Surfactant with | Good | 3.24 × 10⁹ | <0.01 |
| | functional group | | | |
| | containing Ni | | | |
| Sample D | N/A | Gap | 1.40 × 10¹⁰ | <0.01 |

The insulating material supply unit 104 includes at least one feeder (feeders 130a and 130b are shown in FIG. 1), at least one spinning pump (spinning pumps 132a and 132b are shown in FIG. 1), and at least one extruder (extruders 134a and 134b are shown in FIG. 1). In this embodiment, the spinning unit 100 has two spinnerets 106, for example, and thus the insulating material supply unit 104 includes two feeders, two spinning pumps, and two extruders. In detail, the spinning pump 132a is connected with one of the spinnerets 106, and the extruder 134a is connected between the feeder 130a and the spinning pump 132a. In addition, the spinning pump 132b is connected with the other spinneret 106, and the extruder 134b is connected between the feeder 130b and the spinning pump 132b. In other embodiment, if the spinning unit 100 has the spinnerets of another numbers, the numbers of the feeders, the spinning pumps, and the extruders are the same as that of the spinnerets.

In addition, the manufacturing apparatus of the conductive fiber further includes a coiling unit 136 and a cooling unit 138. The coiling unit 136 is used to coil the conductive wire 116 with the surface thereof covered by the insulating material 118. The cooling unit 138 is disposed between the spinning unit 100 and the coiling unit 136, so as to cure the insulating material 118 to form an insulating layer. In addition, the material of the conductive wire 116 is metal, and thus the feeding units 140a and 140b may be additionally disposed between the coiling unit 136 and the cooling unit 138, for transmitting the conductive wire 116. Definitely, the feeding units of different numbers may be disposed according to practical requirements.

Hereinafter, the manufacturing method of a conductive fiber will be illustrated with reference to the manufacturing apparatus as shown in FIGS. 1 and 2.

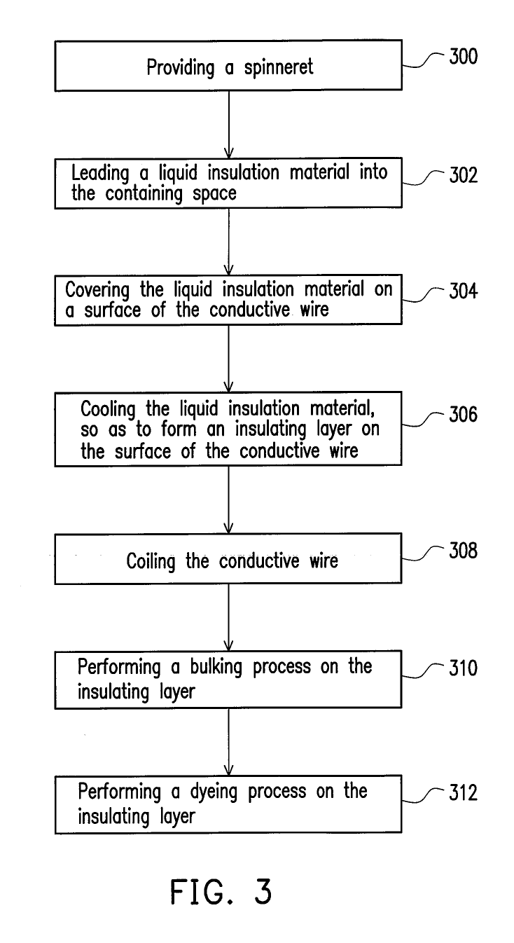

FIG. 3 is a flow chart of the manufacturing method of a conductive fiber according to the embodiment of the present invention. Referring to FIG. 3, first, in step 300, a spinneret is provided. The spinneret has a wire lead-in portion and a liquid lead-in portion. The liquid lead-in portion has a containing space and a capillary, and the wire lead-in portion is disposed in the containing space. Then, in step 302, the liquid insulating material is led into the containing space. As shown in FIGS. 1 and 2, the insulating material 118 is, for example, provided into the containing space 112 through the insulating material supply unit 104. The insulating material is, for example, PET, PA, PP, or PE, and the temperature is, for example, between 200° C. and 310° C. Next, in step 304, the wire lead-in portion leads the conductive wire through the capillary, such that the liquid insulating material is covered on the surface of the conductive wire. The conductive wire is made of, for example, a metal (a copper or a stainless steel), and the diameter is, for example, between 0.02 mm and 0.18 mm. As shown in FIGS. 1 and 2, the conductive wire 116 enters the wire lead-in portion 108 of the spinneret 106 in the spinning unit 100 and passes through the capillary 114 through the wire creel 120, the surfactant coater 124, the drying machine 126, the heater 128, and the wire driving device 122 in sequence. Next, in step 306, the liquid insulating material is cooled, so as to form the insulating layer on the surface of the conductive wire, thereby the fabricating of the conductive fiber is completed.

In addition, the subsequent processing steps may be optionally performed. In step S308, a step of coiling the conductive wire may be performed to coil the conductive wire. Then, in step 310, a bulking processing step may be performed on the insulating layer, so as to achieve the purpose of making the fabrics comfortable. Then, in step 312, a dyeing step may be further performed on the insulating layer. Or, steps such as false twisting, weaving, trimming may be performed.

Hereinafter, an experimental example and a comparative example according to the manufacturing apparatus and method of the present invention are provided.

### EXPERIMENTAL EXAMPLE

Common semidull PET (SDPET) with a characteristic viscosity of 0.62 and a stainless steel with a diameter of 0.025 mm are adopted for composite spinning. The spinning temperature of SDPET is 295° C., thereby obtaining a composite metal fiber with a diameter between 37 and 67 μm. The composite metal fiber is weaved and dyed quickly, so as to obtain the fabrics with superior dyeing behavior and specific gravity value.

### Comparative Example 1

75d/48f Fiber is manufactured by the SDPET with a characteristic viscosity of 0.62. The fiber has a superior dyeing behavior, but does not have specific gravity value.

### Comparative Example 2

The fabrics formed by weaving the metal fibers of 0.025 mm does not have dyeability, but has a good specific gravity value.

In view of the above, in the present invention, the conductive wire and the liquid insulating material are respectively provided to the spinneret at the same time through the wire lead-in portion and the liquid lead-in portion of the spinneret, so as to form the insulating layer on the surface of the conductive wire, and accelerate the manufacturing of the conductive fiber, and also simplify the processing steps of manufacturing the conductive fiber.

In addition, the outer layer of the conductive fiber manufactured according to the manufacturing apparatus of the present invention is the common synthetic fiber, which is different from the composite fiber added with the conductive substances in the conventional art, and thus the dyeing step may be performed thereon to form the color yarn.

In addition, the conductive fiber manufactured according to the manufacturing apparatus and method of the present invention has a high conductivity, such that the antistatic fiber may be improved to have conductivity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing apparatus of conductive fiber, comprising:
a spinning unit having at least one spinneret, wherein the spinneret comprises a wire lead-in portion and a liquid lead-in portion connected with the wire lead-in portion, the liquid lead-in portion has a containing space and a capillary, and the wire lead-in portion is disposed in the containing space;
a conductive wire supply unit connected with the wire lead-in portion to lead a conductive wire through the capillary; and
an insulating material supply unit connected with the liquid lead-in portion to supply a liquid insulating material to the containing space such that the liquid insulating material is covered on a surface of the conductive wire passing through the capillary.

2. The manufacturing apparatus of conductive fiber according to claim 1, wherein the conductive wire supply unit comprises:
a wire creel; and
a wire driving device disposed between the wire creel and the spinneret.

3. The manufacturing apparatus of conductive fiber according to claim 2, wherein the conductive wire supply unit further comprises a heater disposed between the wire creel and the wire driving device.

4. The manufacturing apparatus of conductive fiber according to claim 2, wherein the conductive wire supply unit further comprises a surfactant coater disposed between the wire creel and the wire driving device.

5. The manufacturing apparatus of conductive fiber according to claim 4, wherein the conductive wire supply unit further comprises a drying machine disposed between the surfactant coater and the heater.

6. The manufacturing apparatus of conductive fiber according to claim 1, wherein the insulating material supply unit comprises:
a feeder;
a spinning pump connected with the spinneret; and
an extruder connected between the feeder and the spinning pump.

7. The manufacturing apparatus of conductive fiber according to claim 1, further comprising:
a coiling unit for coiling the conductive wire with the surface thereof covered by the insulating layer; and
a cooling unit disposed between the spinning unit and the coiling unit, so as to cure the insulating material into an insulating layer.

8. The manufacturing apparatus of conductive fiber according to claim 1, further comprising a feeding unit disposed between the coiling unit and the cooling unit.

9. A manufacturing method of conductive fiber, comprising:
providing a spinneret having a wire lead-in portion and a liquid lead-in portion connected with the wire lead-in portion, wherein the liquid lead-in portion has a containing space and a capillary, and the wire lead-in portion is disposed in the containing space;
leading a liquid insulating material into the containing space;
leading a conductive wire through the capillary by the wire lead-in portion such that the liquid insulating material covers a surface of the conductive wire; and
curing the liquid insulating material to form an insulating layer on the surface of the conductive wire.

10. The manufacturing method of conductive fiber according to claim 9, wherein the liquid insulating material is provided into the containing space by an insulating material supply unit.

11. The manufacturing method of conductive fiber according to claim 9, wherein a temperature of the liquid insulating material led into the containing space is between 200° C. and 310° C.

12. The manufacturing method of conductive fiber according to claim 9, wherein a diameter of the wire is between 0.02 mm and 0.18 mm.

13. The manufacturing method of conductive fiber according to claim 9, further comprising performing a dyeing or bulking process on the insulating layer.

14. The manufacturing method of conductive fiber according to claim 9, further comprising coiling the conductive wire with the surface thereof covered by the insulating layer.
